(19) United States
(12) Patent Application Publication
(10) Pub. No.: US 2003/0154114 A1
(43) Pub. Date: Aug. 14, 2003

(54) System and method for capturing and manipulating tradeshow attendee information

(75) Inventor: William R. Lucarelli, Strongsville, OH (US)

Correspondence Address: Timothy E. Nauman, Esq., Fay, Sharpe, Fagan, Minnich & McKee, LLP, 7th Floor, 1100 SuperiorAvenue, Cleveland, OH, 44114-2518, US

(73) Assignee: Lucarelli Designs & Displays, Inc.

(21) Appl. No.: 10/357,806

(22) Filed: Feb. 4, 2003

Related U.S. Application Data
(60) Provisional application No. 60/356,607, filed on Feb. 13, 2002.

(51) Int. Cl. G06F 17/60

(52) U.S. Cl. 705/7; 340/572.1; 340/573.1; 340/825.36; 235/376

(57) ABSTRACT

A tradeshow attendee information system for capturing and manipulating tradeshow attendee information is provided. In one embodiment, the system includes: a plurality of transponders for transmitting tradeshow attendee information, each transponder adapted to be carried by a tradeshow attendee, a first reader antenna for capturing tradeshow attendee information from transponders within wireless communication range of the first reader antenna, a first reader in communication with the first reader antenna for receiving captured tradeshow attendee information, and a first host in communication with the first reader for storing and manipulating the captured tradeshow attendee information. A method for capturing tradeshow attendee information during a tradeshow and manipulating the information to analyze tradeshow attendee behavior is also provided. Additionally, a method for capturing sales lead information during a tradeshow is provided.

This application claims the priority of U.S. Provisional Application Ser. No. 60/356,607, filed Feb. 13, 2002, the disclosure of which is incorporated herein by reference.

### BACKGROUND OF INVENTION

The invention relates to an information system for use in association with tradeshow exhibitions. It finds particular application in conjunction with a system for capturing and manipulating information about attendees at tradeshow exhibitions and methods related to using the system. However, it is to be appreciated that the invention is also amenable to other applications.

Sales lead retrieval systems have been in use for years. For example, each tradeshow attendee is provided with a badge, magnetic card, or the like that provides identifying data relating to the attendee. The name, company, title, address, etc. are representative of the type of data provided on the badge or card. As an attendee visits an exhibitor's booth, the data from the badge or card must be recorded by the exhibitor if the exhibitor wants to capture sales lead information. The exhibitor may imprint information from the attendee's card or badge or swipe the attendee's card whereby data on a magnetic strip is thereby gathered by the exhibitor.

The main problem with a conventional sales lead retrieval system is that it requires interaction between an exhibitor and an attendee to request and record the information. In the scenarios briefly described above, magnetic card readers and imprinters require manual compilation and retrieval of sales lead information. This is not free of error and requires staffing resources for management and collection of the information. Another problem with conventional sales lead retrieval systems is that the exhibitor must be available to request and record the information and any automated capture of the information is limited to reading data. Writing data to the conventional sales lead retrieval system generally requires a manual operation and usually can only be accomplished at registration when the badge or card is issued to an attendee. Another problem with a conventional sales lead retrieval system is that it does not automatically capture certain information, such as, the number of visits by the attendee to the exhibitor's booth, the length of stay at the booth, the specific areas of interest in the booth, other exhibitors visited by the attendee, other areas visited at the tradeshow, and the time and/or type of transactions made by the attendee.

While conventional sales lead retrieval systems may be suitable for a particular purpose, they do not automatically capture certain desired information about attendees at tradeshow exhibitions. Additionally, conventional systems cannot write data to a system component carried by the attendee after the badge or card is initialized. Accordingly, a need exists for a system and associated method of overcoming these shortfalls.

### BRIEF SUMMARY OF INVENTION

The present invention contemplates a system for automatically capturing and manipulating tradeshow attendee information and/or enhancing the type of collected data.

In one aspect of the invention, a method for capturing tradeshow attendee information during a tradeshow and manipulating the information to analyze tradeshow attendee behavior is provided. In one embodiment, the method includes: a) providing a plurality of tradeshow attendees each with a transponder for carrying throughout the tradeshow, b) storing first tradeshow attendee information in each transponder associated with the tradeshow attendee carrying the transponder, c) locating a plurality of readers at a strategic locations within a facility associated with the tradeshow, d) transmitting supplemental tradeshow attendee information from each of the plurality of readers in a wireless communication, e) storing the transmitted supplemental tradeshow attendee information associated with a given reader in a given transponder when the given transponder is within wireless communication range of the given reader, f) transmitting the stored tradeshow attendee information from the plurality of transponders in a wireless communication, g) capturing the transmitted stored tradeshow attendee information at a given reader when a given transponder is within wireless communication range of the given reader, and h) manipulating the captured tradeshow attendee information by at least one of analyzing, sorting, storing, displaying, and printing.

In another aspect, a method for capturing sales lead information during a tradeshow is provided. In one embodiment, the method includes: a) providing a tradeshow attendee with a transponder for carrying throughout the tradeshow, b) storing first tradeshow attendee information in the transponder, c) locating a first reader at a first strategic location within a facility associated with the tradeshow, d) transmitting the stored tradeshow attendee information from the transponder in a wireless communication, and e) capturing the transmitted stored tradeshow attendee information at the first reader when the transponder is within wireless communication range of the first reader.

In yet another aspect of the invention, a tradeshow attendee information system for capturing and manipulating tradeshow attendee information is provided. In one embodiment, the system includes: a plurality of transponders for transmitting tradeshow attendee information, each transponder adapted to be carried by a tradeshow attendee, a first reader antenna for capturing tradeshow attendee information from transponders within wireless communication range of the first reader antenna, a first reader in communication with the first reader antenna for receiving captured tradeshow attendee information, and a first host in communication with the first reader for storing and manipulating the captured tradeshow attendee information.

One advantage of the invention is that a system for retrieving sales lead information about tradeshow attendees with little or no human intervention is provided. In particular, little or no human intervention is required during the capture of such information.

Another advantage of the invention is that a system for capturing information about tradeshow attendees that is non-invasive (i.e., requiring no contact) with respect to the attendees is provided.

A further advantage of the invention is found in the provision of an audit trail that shows each exhibit booth visited by an attendee during the tradeshow.

Still further features and advantages of the invention will become apparent to those of ordinary skill in the art upon reading and understanding the description of the invention.

### BRIEF DESCRIPTION OF DRAWINGS

FIG. 1 is a block diagram of a tradeshow attendee information system in an embodiment of the invention superimposed over a portion of a tradeshow layout in an exhibition hall.

FIG. 2 is a block diagram of a tradeshow attendee information system in another embodiment of the invention superimposed over the portion of the tradeshow layout in the exhibition hall.

FIG. 3 is a block diagram of an embodiment of a host used in the tradeshow attendee information systems shown in FIGS. 1 and 2.

FIG. 4 is a block diagram of an embodiment of the reader used in the tradeshow attendee information systems shown in FIGS. 1 and 2.

FIG. 5 is a block diagram of an embodiment of the transponder used in the tradeshow attendee information systems shown in FIGS. 1 and 2.

### DETAILED DESCRIPTION

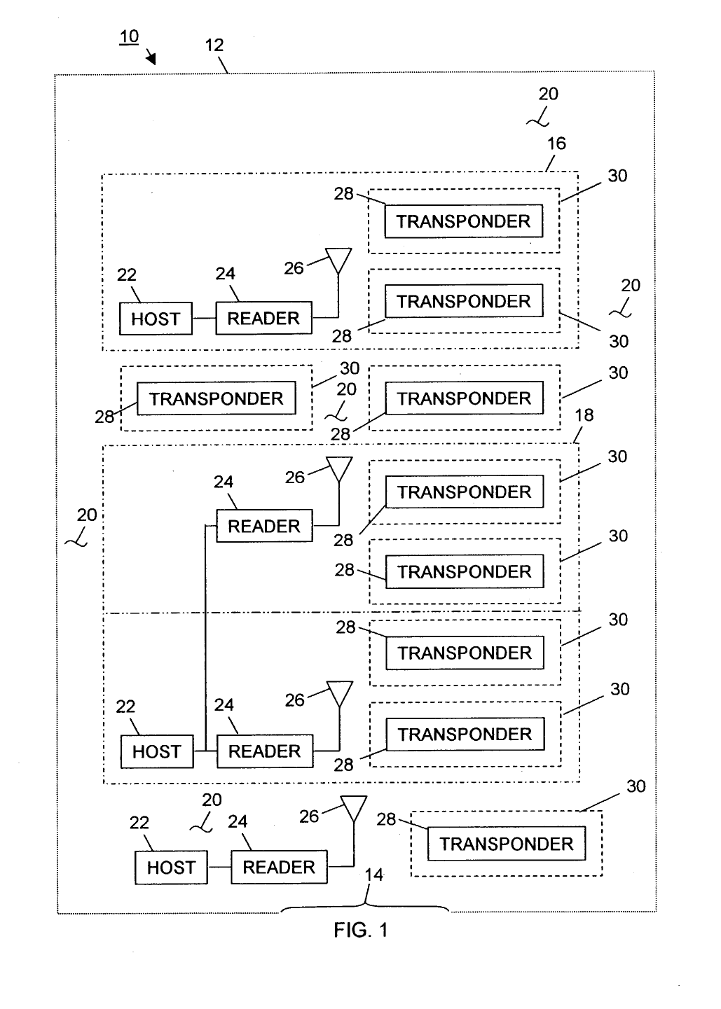

With reference to FIG. 1, a block diagram of a tradeshow attendee information system 10 in an embodiment of the invention is superimposed over a portion of an exemplary tradeshow layout in an exhibition hall 12. It will be appreciated that the tradeshow layout is representative only and can vary from that illustrated and described herein without departing from the scope and intent of the present invention. As shown, there are an entrance/exit 14, a small exhibit booth 16, a large exhibit booth 18, and walkways 20 in the hall 12. The most basic tradeshow attendee information system 10 includes a host 22, a reader 24, a reader antenna 26, and multiple transponders 28. The host 22, reader 24, and reader antenna 26 may be positioned anywhere within the exhibition hall 12. For example, the host 22, reader 24, and reader antenna 26 may be positioned near the entrance/exit 14 to the hall 12.

Alternatively, the host 22, reader 24, and reader antenna 26 may be positioned in either of the exhibit booths 16, 18. As shown, a host 22, reader 24, and reader antenna 26 may be positioned in all three locations. Various combinations of placements and quantities of hosts 22, readers 24, and reader antennae 26 are contemplated. For example, a host 22, reader 24, and reader antenna 26 may be positioned in each exhibit booth (e.g., 16, 18) of the tradeshow and at each entrance/exit 14 to the exhibit hall 12 or in any combination of these locations. Additionally, an exhibit booth may be outfitted with multiple readers 24 connected to the host 22. For example, the large exhibit booth 18 shows a host 22 connected to multiple readers 24, with each reader connected to a reader antenna. The reader, reader antennae, and layout of the exhibit booth in such an arrangement may be designed and matched so that the range of the reader antennae matches logical divisions of products or services within the booth. It is also possible to connect a host to readers in multiple booths (e.g., 16, 18).

The transponders 28 are operationally coupled to badges or tags 30 which are distributed to tradeshow attendees. Typically, a badge or tag 30 is provided to each tradeshow attendee during registration, for example, after they arrive at the exhibition hall 12. Presumably, each tradeshow attendee attaches his/her individualized badge 30 to an article of clothing, thereby carrying the badge 30 and the associated transponder 28 with him/her as the attendee walks through the exhibit hall 12 and through various exhibit booths (e.g., 16, 18).

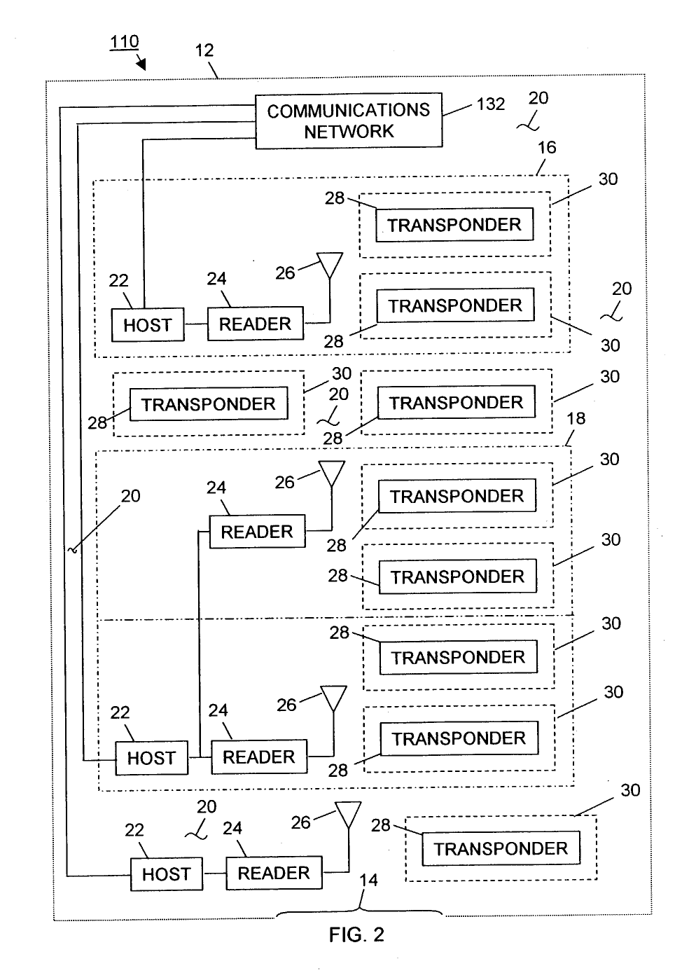

With reference to FIG. 2, a block diagram of a tradeshow attendee information system 110 in another embodiment of the invention is superimposed over the portion of the tradeshow layout in the exhibition hall 12. The tradeshow attendee information system 10 of FIG. 1 is re-configured in a communications network 132. Each host 22 in the tradeshow attendee information system 110, rather than operating in a stand-alone mode, is connected to the communications network 132. Accordingly, any host 22 can communicate with any other host 22 in the tradeshow attendee information system 110. This permits sharing and consolidation of the tradeshow attendee information collected by the hosts 22, as well as sharing of network resources.

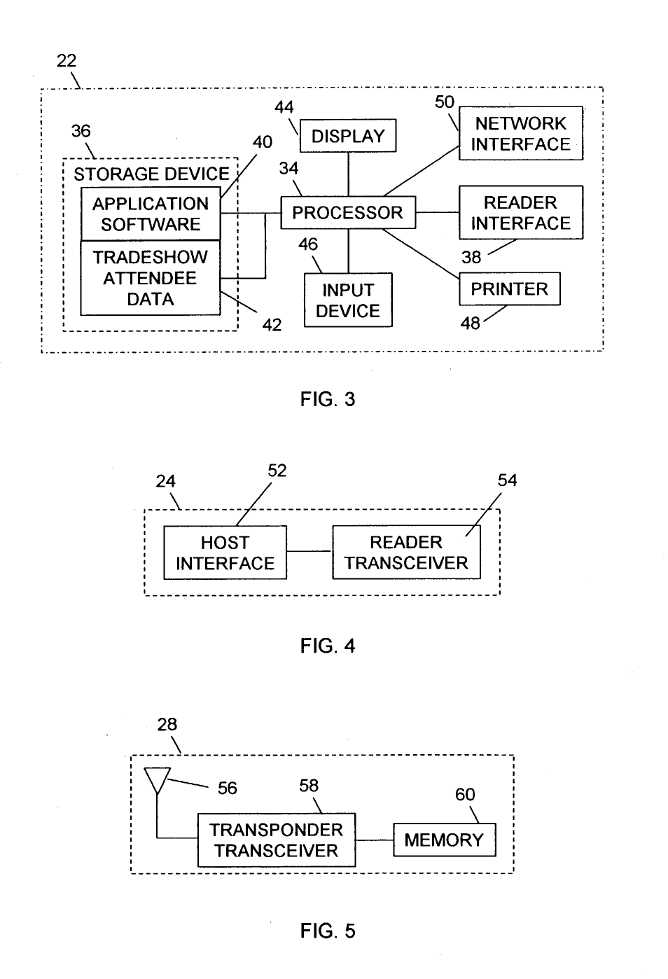

With reference to FIG. 3, a block diagram of an embodiment of the host 22 used in the tradeshow attendee information systems 10, 110 shown in FIGS. 1 and 2 is provided. The host 22 includes a processor 34, a storage device 36, and a reader interface 38. The processor 34 controls the host 22. Application software 40 and tradeshow attendee data 42 are stored in the storage device 36. The reader interface 38 provides a communications port for connection to the reader 24. The host 22 may also include a display 44, an input device 46, a printer 48, and a network interface 50. Other types of internal and external devices may also be included in the host 22, depending on the intended uses and specific needs of users of the system 10, 110.

The host 22 may be a common form of a computer adapted to serve as a host 22 in a tradeshow attendee information system 10, 110. Alternatively, the host 22 may be a device dedicated to function as a host 22 in a tradeshow attendee information system 10, 110.

A block diagram of an embodiment of the reader 24 used in the tradeshow attendee information systems 10, 110 shown in FIGS. 1 and 2 is shown in FIG. 4. The reader 24 includes a host interface 52 and a reader transceiver 54. The host interface 52 provides a communications port for connection to the host 22. The reader transceiver 54 controls transmissions and receptions between the reader 24 and transponders 26 and is connected to the reader antenna 26. In an alternate embodiment, particularly where the host 22 is a device dedicated to function as a host 22 in a tradeshow attendee information system 10, 110, the reader 24 may be an internal device of the host 22.

FIG. 5 is a block diagram of an embodiment of the transponder 28 used in the tradeshow attendee information systems 10, 110 shown in FIGS. 1 and 2. The transponder 28 includes a transponder antenna 56, a transponder transceiver 58, and a memory 60. The transponder antenna 56 provides for wireless communications between the transponder 28 and a reader 24. The transponder transceiver 58 is connected to the transponder antenna 56 and controls transmissions and receptions between the transponder 26 and readers 24. The memory 60 stores information about the tradeshow attendee to whom the associated badge 30 was issued. This embodiment of the transponder 28 does not contain an internal power source and is sometimes referred to as a passive transponder. The passive transponder is powered by signals from an external source, usually the electromagnetic field generated by the reader antenna 26. An alternate embodiment of the transponder 28 includes a battery that partly or completely provides power to the components of the transponder 28. This alternate embodiment of the transponder 28 is sometimes referred to as an active transponder. It is understood in the art that such differences between passive and active transponders affect the cost to produce the transponder 28. Accordingly, the cost to produce the active transponder is usually greater than the cost to produce the passive transponder.

Referring to FIGS. 1-5, from an operational sense, the tradeshow attendee information system 10, 110 includes multiple tags 30, each with a transponder 28 and carried by an attendee, that send information to a reader 24 when the transponder 28 is within range of a reader antenna 26 associated with the reader 24. For example, a passive transponder 28 will send information when the magnetic field radiated by a reader antenna 24 provides sufficient power to excite the transponder 28. Alternatively, an active transponder 28 will send information after receiving a request for information from a reader 24 via a reader antenna 26. It is understood in the art that such differences between passive and active transponders affect the range within which the transponder 28 can communicate with the reader 24. Accordingly, the range of an active transponder is usually greater than the range of a passive transponder. The reader 24 collects attendee information stored in the memory 60 of the transponder 28 using the reader antenna 26. The reader antenna 26 may be contained within the floor coverings or other exhibition hall structure or within the exhibit booth structure. The reader 24 routes the tradeshow attendee information via the host interface 52 to the host 22. The host 22 receives the tradeshow attendee information via the reader interface 38 and stores the information on the storage device 36 as tradeshow attendee data 42. The application software 40 in the host 22 manipulates the tradeshow attendee data 42, including management and analysis of the data 42. If the host 22 includes a display 44, the application software also may permit the data 42 to be displayed. Additionally, if the host 22 includes a printer 48, the application software may permit the data 42 to be printed.

The reader 24 can also be used to transmit data back to the transponder 28 on the fly via the reader antenna 26. The reader antenna 26 controls coverage—the strength, density and shape of the RF field or zone. The reader transceiver 54 controls RF communication functions of the reader 24, including requests for information, reception of data from transponders 28, and transmission of data back to transponders 28. The transponder 28 sends data to the reader 24 when it is within reception range of an associated reader antenna 26. The transponder 28 replies to a request for information from a reader 24 either by returning data stored in the memory 50 of the transponder 28 (e.g., an identity code) or by returning the original properties of the signal received from the reader 24 to permit the reader to make ranging measurements.

As discussed, the transponder 28 is attached to an individual attendee. The transponder 28 may be a badge or tag 30. Alternatively, the transponder 28 may be a pin, decal, contained within a premium, or carried by other means. One of the objects of the system 10, 110 is to create chronological information about the individual attendee as he or she walks through the exhibit hall 12 and visits various exhibit booths (e.g., 16, 18) within the hall 12. The transponder 28 is programmed with unique identification information to be broadcast when the transponder 28 receives a request for information from a reader 24. The identification information usually includes a unique identity code with respect to the current tradeshow and may include information about the individual attendee to whom the transponder 28 was issued. For example, the individual attendee information may include contact information and logistical information about the attendee.

The transponder 28 may also be used to accumulate data transmitted by readers 24 when the transponder 28 is carried within range of the reader 24. The accumulated data is stored in the memory 50 of the transponder 28. As such, the memory 50 has a read/write capability. In operation, a reader 24 may transmit information related to the exhibitor and products and/or services featured in the exhibit booth (e.g., 16, 18) to transponders within range of an associated reader antenna 26. Typically, the information transmitted by the reader 24 includes elapsed time information. The elapsed time information may be divided among certain products or services featured in the exhibit booth (e.g., 18) if multiple reader antennae 26 are used. As the attendee continues walking through the exhibit, subsequent readers 24 receive more and more accumulated information from the transponder 28. Effectively, a reader 24 will receive a snapshot of the attendee's interests as he/she has walked through the tradeshow. If readers 24 are positioned near the exits (e.g., 14), the exit readers 24 may collect comprehensive accumulated information about the tradeshow attendee's path through the exhibition hall 12 and the exhibit booths (e.g., 16, 18) from the transponder 28. The complete accumulated information will reflect a chronological audit trail of each reader that the transponder was carried within range of and the goods and/or services associated with the reader.

The reader antenna 26 controls coverage—the strength, density and shape of the RF field or zone. The reader antenna 26 emits RF signals to activate the transponder 28. The reader 24 receives data from the transponder 28 and transmits data to the transponder 28 via the reader antenna 26. Similarly, the transponder 28 transmits data to the reader 24 and receives data from the reader 24 via the transponder antenna 56. The antennae 26, 56 are the conduits between the transponder transceiver 58 and the reader transceiver 54. The readers 24 control data acquisition and RF communications by the system 10, 110. The reader antennae 26 may vary in shape and size. The reader antennae 26 can be built into a door frame, laid under carpeting, or contained in components or exhibit structure. The electromagnetic field produced by a reader antenna 26 can be continuous or periodical. The reader 24 can continuously read multiple tags within range of an associated reader antenna 26. If continuous interrogation is not required, the transponder 28 can activate the electromagnetic field.

The reader antenna 26 is installed or built into exhibit components to track the activity within a zone of the exhibit booth. The combination of a host 22, reader 24, and reader antenna 26 can be marketed as an individual product. For example, smart floor coverings, smart platforms, kiosks, or other components may include a host 22, reader 24, and reader antenna 26.

The reader transceiver 54 controls RF communication functions of the reader 24. The reader transceiver 54 emits an RF signal via the reader antenna 26 to create an electromagnetic field or zone. A passive transponder 28 becomes excited when entering within range of the electromagnetic field. Once excited, the transponder 28 emits a low power RF signal received by the reader antenna 26. Alternatively, an active transponder 28 emits an RF signal captured by the reader 24 and simultaneously receives and stores the RF signal transmitted by the reader 24. Alternatively, reader 24 transmits a request for information to the transponder 28, receives tradeshow attendee information from the transponder 28, and communicates the tradeshow attendee information to the host 22 where it is stored in the storage device 36 as tradeshow attendee data 42 by the application software 40. Alternatively, the reader 24 and reader antenna 26 could be incorporated into a single device.

The application software 40 manipulates the tradeshow attendee data 42, including management and analysis of the data 42. If the host includes a display 44, the application software also permits and controls display of the tradeshow attendee data 42. The application software 40 stores and interprets the tradeshow attendee data 42 collected from the transponders 28. The tradeshow attendee data 42 can be analyzed, sorted, stored, entered into reports, and printed by users of the host 22. As part of the tradeshow attendee data 42, the movement and logistics of attendees associated with transponders 28 that have been read by the reader 24 can be stored. This permits the exhibitor to track the history of movements of each transponder 28 and associated attendee through the various exhibit booths (e.g., 16, 18) of the tradeshow. This tracks the transponder 28 and associated attendee throughout his or her daily travels through the exhibition hall 12, leaving an audit trail that can reviewed and analyzed in real-time (i.e., when the attendee is in the exhibitor's booth) or at a later time. The application software is modular and compatible with various computer architectures and operating systems. For example, the application software can be used in a common form of a computer or in a dedicated device.

The system and method for capturing and manipulating tradeshow attendee information uses a transponder 28 incorporated, worn, or carried by each attendee of a tradeshow in a badge 30 or similar article. The transponder 28 includes a memory 50 that can be preprogrammed with information about the attendee to whom the badge 30 was issued. The memory 50 can also be written in real-time by readers 24 positioned at various locations throughout the exhibition hall 12 when the transponder 28 is brought within range of a reader antenna 26 associated with a given reader 24. The transponder 28 emits a signal when within the range (i.e., within the electromagnetic field or zone) of a reader antenna 26 and collects information from the transponder 28 that is stored in the memory 50. The reader 24 collects the attendee information and routes it to the host 22 where it is stored in the storage area 36 as tradeshow attendee data 42 by the application software 40. The application software 40 is used to collect, store, interpret, and sort the tradeshow attendee data 42. The data 42 can also be analyzed and incorporated into reports by the application software 40. The host computer 22, reader 24, and reader antenna 26 could be incorporated into an exhibition hall 12, convention center, or meeting facility.

Each attendee is given an article, such as a badge or tag 30, that includes the transponder 28 at the entrance of the tradeshow, typically during the tradeshow registration process. The badge 30 or similar type of article is typically attached to the attendee's clothing or otherwise carried by the attendee as the attendee walks through the exhibit hall 12 and visits various exhibit booths (e.g., 16, 18). Within the exhibition hall 12, the exhibitors may use readers 24 within specific and/or general areas of their exhibit booth (e.g., 18). These areas or zones can be used to segregate product lines, services, new products, demonstrations, presentations or other areas of interest. When the attendee enters the exhibitor's booth (e.g., 18) within range of a reader 24, the reader 24 captures information stored in the memory 50 of the transponder 28 carried by the attendee. The reader 24 may also send information to the transponder 28 worn by the attendee for storage in the memory 50. The tradeshow attendee information stored in the memory 50 may include contact information for future communications and marketing, and a history of movement by the attendee within the exhibition hall 12, various exhibit booths (e.g., 16), and the exhibitor's own booth (e.g., 18). For example, the exhibitor could capture this data and learn that the attendee has just visited a competitor's exhibit booth (e.g., 16) and alter a sales presentation to accentuate the features of the products and services of the particular exhibitor. Another example would be that the exhibitor could create multiple zones within its exhibit booth (e.g, 18) that are based on different products or services and capture a history of activity within each zone of its own exhibit booth. This would enable the exhibitor to evaluate the effectiveness of the product presentation and the level of interest with the attendees of the tradeshow.

In addition to the previous examples, the readers replace traditional imprinters used by exhibitors and do not require any interaction in order to capture information about the attendee. The system minimizes exhibitor staffing, eliminates missed opportunities to capture tradeshow attendee information, and provides reliable, relatively error-free information about the amount of time each attendee: a) spends in the exhibitor's booth, b) spends in zones of the exhibitor's booth, c) spends in other booths of other exhibitors, and d) spends in various other areas of the exhibition hall 12. The system 10, 110 also provides reliable, relatively error-free contact information for attendees that visited the exhibitor's booth for follow-up marketing.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

What is claimed is:

1. A method for capturing sales lead information during a tradeshow, including the following steps:
a) providing a tradeshow attendee with a transponder for carrying throughout the tradeshow;
b) storing first tradeshow attendee information in the transponder;
c) locating a first reader at a first strategic location within a facility associated with the tradeshow;
d) transmitting the stored tradeshow attendee information from the transponder in a wireless communication; and
e) receiving the transmitted stored tradeshow attendee information at the first reader when the transponder is within wireless communication range of the first reader.

2. The method set forth in claim 1, wherein the first tradeshow attendee information includes at least one of unique identity information associated with the tradeshow and the tradeshow attendee, contact information associated with the tradeshow attendee, and logistical information associated with the tradeshow attendee.

3. The method set forth in claim 1, further including the following steps before step d):
f) locating a plurality of additional readers at strategic locations within the facility;
g) transmitting supplemental tradeshow attendee information from the readers in a wireless communication; and
h) storing the transmitted supplemental tradeshow attendee information in the transponder when the transponder is within wireless communication range of the reader.

4. The method set forth in claim 3, further including the following step:
i) manipulating the captured tradeshow attendee information by at least one of analyzing, sorting, storing, displaying, and printing.

5. The method set forth in claim 4, wherein the first reader is located in an exhibit booth and the captured tradeshow attendee information is displayed on a display device in the exhibit booth while the tradeshow attendee is within wireless communication range of the first reader.

6. The method set forth in claim 4, wherein the first reader is located in a zone of an exhibit booth, the zone being associated with a particular product/service, and the captured tradeshow attendee information is displayed on a display device in the exhibit booth while the tradeshow attendee is within wireless communication range of the first reader.

7. A method for capturing tradeshow attendee information during a tradeshow and manipulating the information to analyze tradeshow attendee behavior, including the following steps:
a) providing a plurality of tradeshow attendees each with a transponder for carrying throughout the tradeshow;
b) storing first tradeshow attendee information in each transponder associated with the tradeshow attendee carrying the transponder;
c) locating a plurality of readers at strategic locations within a facility associated with the tradeshow;
d) transmitting supplemental tradeshow attendee information from each of the plurality of readers in a wireless communication;
e) storing the transmitted supplemental tradeshow attendee information associated with a given reader in a given transponder when the given transponder is within wireless communication range of the given reader;
f) transmitting the stored tradeshow attendee information from the plurality of transponders in a wireless communication; and
g) receiving the transmitted stored tradeshow attendee information at a given reader when a given transponder is within wireless communication range of the given reader.

8. The method set forth in claim 7, further including the following step:
h) manipulating the captured tradeshow attendee information by at least one of analyzing, sorting, storing, displaying, and printing.

9. The method set forth in claim 7, wherein the supplemental tradeshow attendee information includes unique location information associated with the reader and time information associated with the time and date the supplemental tradeshow attendee information was transmitted.

10. The method set forth in claim 7, wherein at least one of the plurality of readers is located at an exit to the tradeshow.

11. The method set forth in claim 7, wherein the transmitted stored tradeshow attendee information captured by the at least one reader located at the exit provides an audit trail of unique location information and time information associated with readers that the tradeshow attendee carrying a given transponder came within wireless communication range thereof.

12. A tradeshow attendee information system for capturing and manipulating tradeshow attendee information, including:
a plurality of transponders for transmitting tradeshow attendee information, each transponder adapted to be carried by a tradeshow attendee;
a first reader antenna for capturing tradeshow attendee information from transponders within wireless communication range of the first reader antenna;
a first reader in communication with the first reader antenna for receiving captured tradeshow attendee information; and
a first host in communication with the first reader for storing and manipulating the captured tradeshow attendee information.

13. The tradeshow attendee information system set forth in claim 12, further including:
a second reader antenna for capturing tradeshow attendee information from transponders within wireless communication range of the second reader antenna; and
a second reader in communication with the second reader antenna for receiving captured tradeshow attendee information.

14. The tradeshow attendee information system set forth in claim 13, wherein the first host is in communication with the second reader.

15. The tradeshow attendee information system set forth in claim 13, further including:
a second host in communication with the second reader for storing and manipulating the captured tradeshow attendee information.

16. The tradeshow attendee information system set forth in claim 15, further including:
a communications network interconnecting the first host and the second host for sharing captured tradeshow attendee information between the first host and second host.

17. The tradeshow attendee information system set forth in claim 12, at least one transponder of the plurality of transponders including:
a memory for storing tradeshow attendee information;
a transponder transceiver in communication with the memory; and
a transponder antenna in communication with the transponder transceiver for wirelessly communicating the tradeshow attendee information to the first reader when the transponder is within wireless communication range of the first reader antenna.

18. The tradeshow attendee information system set forth in claim 17, wherein the at least one transponder is at least partially powered by signals from an electromagnetic field associated with the first reader antenna when the transponder is within a predetermined distance of the first reader antenna.

19. The tradeshow attendee information system set forth in claim 17, the at least one transponder further including:
a battery for at least partially providing power to the memory, transponder transceiver, and transponder antenna.

20. The tradeshow attendee information system set forth in claim 12, the first reader including:
a reader transceiver in communication with the first reader antenna for receiving captured tradeshow attendee information; and
a host interface in communication with the reader transceiver for communicating the captured tradeshow attendee information to the first host.

21. The tradeshow attendee information system set forth in claim 12, the first host including:
a reader interface in communication with the first reader for receiving the captured tradeshow attendee information;
a storage device for storing the captured tradeshow attendee information; and
a processor in communication with the reader interface and the storage device for controlling the host and manipulating the captured tradeshow attendee information.
